(19) United States
(12) Patent Application Publication
(10) Pub. No.: US 2014/0230536 A1
(43) Pub. Date: Aug. 21, 2014

(54) DISTRIBUTED ACOUSTIC MONITORING VIA TIME-SHEARED INCOHERENT FREQUENCY DOMAIN REFLECTOMETRY

(71) Applicants: Roger Glen Duncan, Christiansburg, VA (US); Matthew Thomas Raum, Blacksburg, VA (US)

(72) Inventors: Roger Glen Duncan, Christiansburg, VA (US); Matthew Thomas Raum, Blacksburg, VA (US)

(73) Assignee: Baker Hughes Incorporated, Houston, TX (US)

(21) Appl. No.: 13/768,113

(22) Filed: Feb. 15, 2013

(51) Int. Cl. G01V 11/00

(52) U.S. Cl. CPC G01V 11/00
USPC 73/152.01

(57) ABSTRACT

A system and method to obtain an acoustic signal from a borehole penetrating the earth are described. The system includes a modulated single frequency incoherent light source to output a modulated light signal. The system also includes two or more optical fibers to split the modulated light signal for transmission to an optical sensor in the borehole, at least one of the two or more optical fibers including a delay, two or more photodetectors to receive respective resultant signals resulting from the two or more optical fibers transmitting the modulated light signal to the optical sensor, and a processor to obtain the acoustic signal based on the resultant signals.

### BACKGROUND

In downhole exploration and production, sensors and monitoring systems provide information about the downhole environment and the formation. For example, distributed acoustic measurements have been found to be useful in production monitoring of oil and gas wells as well as in other applications. Some existing distributed acoustic measurement systems use low-signal measurements of the native Rayleigh scatter in an optical fiber. While these systems can provide useful data, they suffer from a low tolerance for signal losses.

### SUMMARY

According to one aspect of the invention, a system to obtain an acoustic signal from a borehole penetrating the earth includes a modulated single frequency incoherent light source to output a modulated light signal; two or more optical fibers to split the modulated light signal for transmission to an optical sensor in the borehole, at least one of the two or more optical fibers including a delay; two or more photodetectors to receive respective resultant signals resulting from the two or more optical fibers transmitting the modulated light signal to the optical sensor; and a processor to obtain the acoustic signal based on the resultant signals.

According to another aspect of the invention, a method of obtaining an acoustic signal from a borehole penetrating the earth includes modulating a single frequency incoherent light source to output a modulated light signal; disposing two or more optical fibers to receive and split the modulated light signal; adding a delay in at least one of the two or more optical fibers; transmitting, through each of the two or more optical fibers, the modulated light signal to an optical sensor in the borehole; receiving, with two or more photodetectors, respective resultant signals resulting from the two or more optical fibers transmitting the modulated light signal to the optical sensor; and processing the resultant signals to obtain the acoustic signal.

### BRIEF DESCRIPTION OF THE DRAWINGS

Referring now to the drawings wherein like elements are numbered alike in the several Figures:

FIG. 1 is a cross-sectional illustration of a borehole and a distributed acoustic sensor system according to an embodiment of the invention;

FIG. 2 details the components of the distributed acoustic sensor system shown in FIG. 1 according to an embodiment of the invention; and

FIG. 3 is a flow diagram of a method of obtaining acoustic information from the downhole environment using a time-sheared incoherent optical frequency domain reflectometry (IOFDR) system.

### DETAILED DESCRIPTION

As noted above, present distributed acoustic measurement systems can be sensitive to signal losses. Another type of measurement system is an incoherent optical frequency domain reflectometry (IOFDR) network. In an IOFDR network, source light is amplitude modulated with a chirped frequency and sent to a device under test (DUT). The DUT may be, for example, an optical fiber sensing a parameter of interest (e.g., temperature, strain) downhole. The light reflects off the native backscatter of the optical fiber (DUT) or from a deterministic reflector such as a fiber Bragg grating (FBG). The returned light is directed to a photodetector for optoelectronic conversion, amplification, and processing. Embodiments of the invention described herein relate to an IOFDR network that can detect downhole acoustic signals. Specifically, the embodiments describe a time-sheared IOFDR system that facilitates obtaining acoustic measurements.

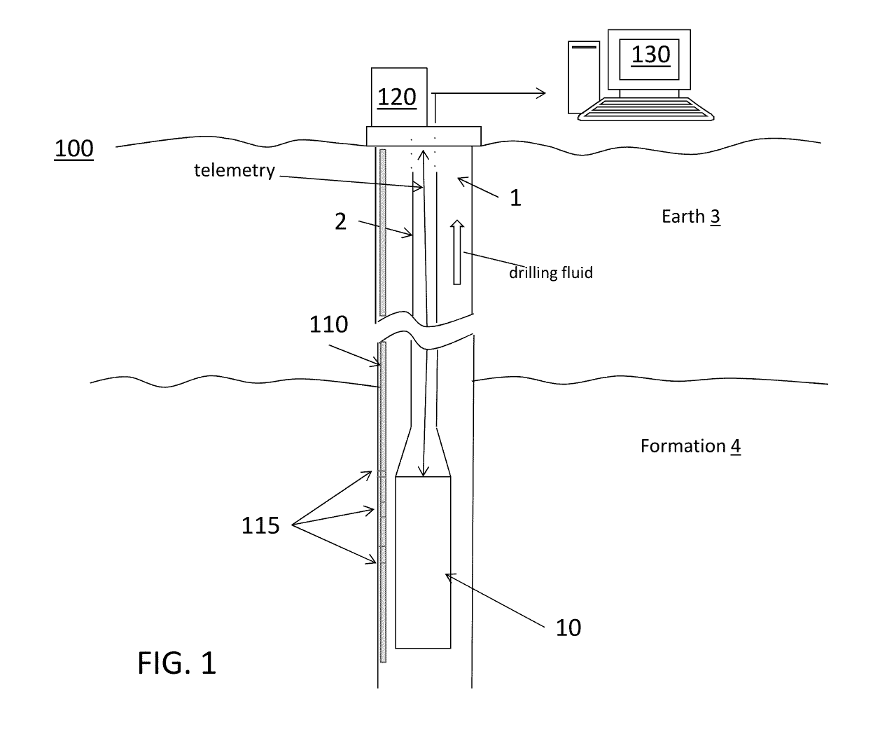

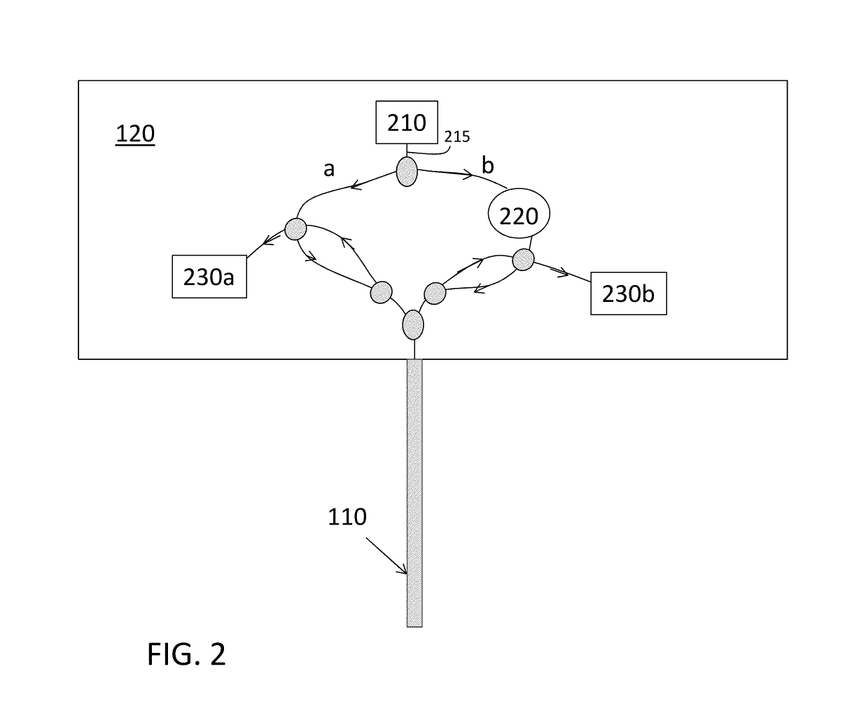

FIG. 1 is a cross-sectional illustration of a borehole 1 and a distributed acoustic sensor system 100 according to an embodiment of the invention. A borehole 1 penetrates the earth 3 including a formation 4. A set of tools 10 may be lowered into the borehole 1 by a string 2. In embodiments of the invention, the string 2 may be a casing string, production string, an armored wireline, a slickline, coiled tubing, or a work string. In measure-while-drilling (MWD) embodiments, the string 2 may be a drill string, and a drill would be included below the tools 10. Information from the sensors and measurement devices included in the set of tools 10 may be sent to the surface for processing by the surface processing system 130 via a fiber link or telemetry. The surface processing system 130 (e.g., computing device) includes one or more processors and one or more memory devices in addition to an input interface and an output device. The distributed acoustic sensor system 100 includes an optical fiber 110 (DUT). In the embodiment shown in FIG. 1, the optical fiber 110 includes fiber Bragg gratings (FBGs) 115. The distributed acoustic sensor system 100 also includes components 120 detailed in FIG. 2, which are shown at the surface of the earth 3 in FIG. 1.

FIG. 2 details the components 120 of the distributed acoustic sensor system 100 shown in FIG. 1 according to an embodiment of the invention. The components 120 include a light source 210, delay 220, and photodetectors 230. According to the present embodiment, the light source 210 is a single frequency source that is amplitude modulated with a chirped frequency. In the embodiment shown in FIG. 2, the modulated light source 210 signal 215 is split into two paths (a, b). A delay 220 is inserted in one of the two paths (b) in the form of additional optical fiber whose length corresponds to the desired delay in the signal 215 on that path (b). In alternate embodiments, the light source 210 signal 215 may be split into more than two paths. In that case, each of the additional paths may have different delays associated with them. The delay 220 may be fixed or configurable. When the delay 220 is configurable, the delay 220 may be changed between transmissions of the signal 215 along the optical fiber 110. The delay 220 is proportional to the desired acoustic sampling frequency. That is, the delay should be smaller than the time-scale of the acoustic signal of interest in order to obtain the acoustic signal. The signals at the photodetectors 230a and 230b resulting from the light source 210 signal 215 (path a) and the delay 220 in the signal 215 are nominally identical but with a delay. For example, when the additional optical fiber in path b is of a length 10 km, assuming a refractive index of 1.5, the delay introduced is 50 micro seconds (μs) [(length*index of refraction)/speed of light]. Acoustic signals of interest may be, for example, on a time-scale of milliseconds. Thus, as noted above, the smaller delay facilitates detection of the acoustic signal of interest. By taking a difference of the signals acquired via paths a and b (at photodetectors 230a and 230b), the static portion of the measurement is removed, leaving only the dynamic portion. This dynamic portion is presumed to be attributable to an acoustic source. The processing to obtain the dynamic portion may be done by the surface processing system 130, for example. The processing may be in the time and/or frequency domains. When additional splits (additional to paths a and b) are used, additional samples of the dynamic signals are be obtained. As noted above, when additional splits are used, each resulting additional path may be delayed by a different amount in order to distinguish the dynamic portion based on the resultant signals at the respective photodetectors 230.

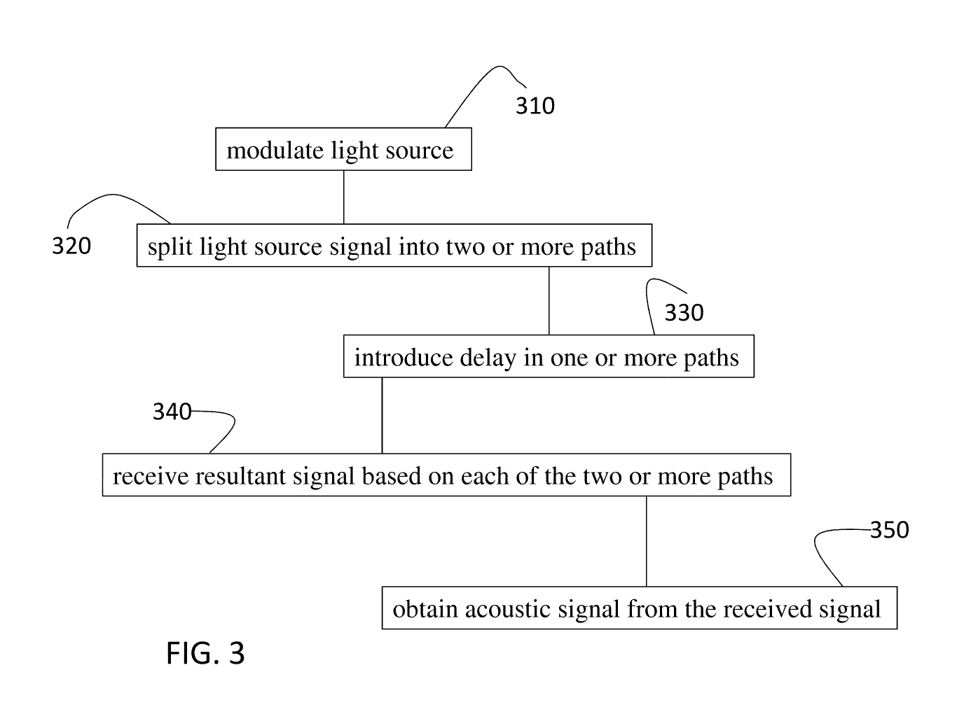

FIG. 3 is a flow diagram of a method of obtaining acoustic information from the downhole environment using a time-sheared incoherent optical frequency domain reflectometry (IOFDR) system. At block 310, modulating the light source 210 includes amplitude modulating a single frequency light signal with a chirp frequency. At block 320, the method includes splitting the resulting light source 210 signal 215 into two or more paths (e.g., a, b shown in FIG. 2). Introducing a delay 220 in one or more paths at block 330 may include introducing a fixed or configurable delay 220. Introducing the delay 220 may be accomplished by using an optical fiber with a longer length corresponding to the desired delay 220. When three or more paths are created by the split of the modulated light source 210 signal 215, two or more (or all) of the paths may include a delay 220 where the delay 220 in each path is different from the delay 220 in any other path. Receiving a resultant signal based on each of the two or more paths at block 340 includes receiving each resultant signal at a different photodetector 230. Obtaining an acoustic signal from the received signal at the photodetectors 230 at block 350 includes subtracting the static portion of the received signal to obtain the dynamic portion attributable to one or more downhole acoustic sources.

While one or more embodiments have been shown and described, modifications and substitutions may be made thereto without departing from the spirit and scope of the invention. Accordingly, it is to be understood that the present invention has been described by way of illustrations and not limitation.

1. A system to obtain an acoustic signal from a borehole penetrating the earth, the system comprising:
a modulated single frequency incoherent light source to output a modulated light signal;
two or more optical fibers to split the modulated light signal for transmission to an optical sensor in the borehole, at least one of the two or more optical fibers including a delay;
two or more photodetectors to receive respective resultant signals resulting from the two or more optical fibers transmitting the modulated light signal to the optical sensor; and
a processor to obtain the acoustic signal based on the resultant signals.

2. The system according to claim 1, wherein the modulated single frequency incoherent light source is amplitude modulated by a chirp frequency.

3. The system according to claim 1, wherein the at least one of the two or more optical fibers includes additional optical fiber whose length corresponds to the delay.

4. The system according to claim 1, wherein the delay is a fixed delay.

5. The system according to claim 1, wherein the delay is configurable between transmissions to the optical sensor.

6. The system according to claim 1, wherein the delay is selected proportional to a desired acoustic sampling frequency.

7. The system according to claim 1, wherein the processor obtains the acoustic signal from a difference of the resultant signals.

8. A method of obtaining an acoustic signal from a borehole penetrating the earth, the method comprising:
modulating a single frequency incoherent light source to output a modulated light signal;
disposing two or more optical fibers to receive and split the modulated light signal;
adding a delay in at least one of the two or more optical fibers;
transmitting, through each of the two or more optical fibers, the modulated light signal to an optical sensor in the borehole;
receiving, with two or more photodetectors, respective resultant signals resulting from the two or more optical fibers transmitting the modulated light signal to the optical sensor; and
processing the resultant signals to obtain the acoustic signal.

9. The method according to claim 8, wherein the modulating the single frequency incoherent light source includes applying amplitude modulation with a chirp frequency.

10. The method according to claim 8, wherein adding the delay includes adding optical fiber whose length corresponds to the delay.

11. The method according to claim 8, wherein adding the delay includes adding a fixed delay.

12. The method according to claim 8, wherein adding the delay includes adding a configurable delay that is configured between the transmitting to the optical sensor.

13. The method according to claim 8, wherein adding the delay includes selecting the delay proportional to a desired acoustic sampling frequency.

14. The method according to claim 8, wherein the processing to obtain the acoustic signal includes taking a difference of the resultant signals.
